(19) United States
(12) Patent Application Publication
(10) Pub. No.: US 2004/0179653 A1
(43) Pub. Date: Sep. 16, 2004

(54) Method for managing monitoring data

(76) Inventors: Norbert Kreusch, Neuried (DE); Helmut Stifter, Munchen (DE)

Correspondence Address: MORRISON & FOERSTER LLP, 1650 TYSONS BOULEVARD, SUITE 300, MCLEAN, VA, 22102, US

(21) Appl. No.: 10/472,395

(22) PCT Filed: Mar. 7, 2002
(86) PCT No.: PCT/EP02/02525

(30) Foreign Application Priority Data
Mar. 21, 2001 (EP) 01107062.0

(51) Int. Cl. H04M 3/08; H04M 1/24

(52) U.S. Cl. 379/1.03; 379/32.01

(57) ABSTRACT

A method and telecommunications system (SYS) for administering monitoring data (ÜDA) that serve to monitor a telecommunications terminal (TEA) by means of a home exchange (VEA) assigned to it on an intelligent network (INN), wherein the monitoring data (ÜDA) are monitored centrally at a selected exchange (VEZ) on the intelligent network, which exchange performs the monitoring of the telecommunications terminal (TEA) using these monitoring data (DAT).

The invention relates to a method for administering monitoring data that are used to monitor a telecommunications terminal using an assigned home exchange of an intelligent network.

In addition, the invention relates to a telecommunications system that is set up to administer monitoring data that are used to monitor a telecommunications terminal using an assigned home exchange of an intelligent network.

An intelligent network, abbreviated IN, involves a network design with which telecommunications services can be offered more cost-effectively. An intelligent network is not a special physical network platform but a service-oriented architecture that is based on a previously existing network structure, for example the PSTN network, and providing this with additional performance characteristics. Generally, the performance characteristics are administered centrally at an IN exchange.

“Service control points” serve as a control point for the services on the IN, whereby addresses at which they can be reached are assigned to all network components on the IN. The service control point can be a computer or a database system that runs service programs and provides customer service via a switch system.

The function of the service control points consists essentially in that they take over traffic administration for the IN connections and administration of fee-related and statistical data with the support of central databases.

In doing so, the “service management point” takes over data for the purposes of configuration and service management. When an IN service is used, a request for a so-called “service switching point,” abbreviated SSP, is detected and processed by the SCP. SSP nodes are digital exchanges that are equipped with special control functions. They detect the intelligent telecommunications services and take over service-neutral connection control on an intelligent network. The recommendations of the ITU describe intelligent networks under Q.1200.

Since the functional elements of exchange and service are separated from each other, intelligent networks are more flexible in approach than other exchange-oriented networks. Exchange functions in the design of intelligent networks are no longer exclusively concentrated on the exchanges but can be performed by special computers, the “service switching points” already mentioned above. Tasks relating to exchange technology are generally executed via an SS#7 network. When the functions of exchange and service are separated, we speak of divided service characteristic control.

Because of their service-neutral software, intelligent networks can generate new services rapidly. The essential difference to all other network designs thus lies in the opportunities to implement new network-independent services rapidly. This way, services can be defined by a simple description, the so-called service plan.

In addition, they are independent of the services provided and the existing networks.

From a user perspective, an intelligent network thus involves a number of performance characteristics that make it possible to optimize telecommunications processes.

Lawmakers increasingly demand that operators of intelligent networks make functions available that make it possible to monitor the data exchange of individual users, when necessary.

The problem of legal tapping of data streams, so-called “lawful interception,” on an intelligent network is currently solved in various ways.

Normally, data traffic on an intelligent network is monitored in a decentralized manner. This means that all data that are needed to administer and implement monitoring must be present at all exchanges with SSP functionality (IN connections can be processed only here). These data that are necessary to administer and implement monitoring are called monitoring data in this document, and they contain information known from prior art about how tapping should take place, for example whether tickets are to be created—a ticket contains information about which system functions, for example an alarm order, are activated via the telecommunications terminal or whether speech data will be recorded—see standards ETSI ES 201,158, EZSI ES 201,671, and ETSI ER 331 on this. Monitoring data can also contain routing information about where the result data that is recorded within the framework of the monitoring should be sent, for example for purposes of evaluation. Monitoring data can also contain information about how and whether the address of a telecommunications terminal to be monitored should be coded, for example, whether an assignable identification number can be transmitted instead of the address.

The monitoring data can be used in a monitoring situation to establish a monitoring connection.

If a new monitoring case must be set up, this must be implemented at all exchanges with SSP functionality. On the term “lawful interception” on an “intelligent network,” see also standard ETSI ER 201,781 V1.1.1.

The procedure described above requires expensive administrative work by monitoring officials in order to keep the data consistent. If, for example, an exchange is reequipped with SSP functionality and monitoring officials are not informed immediately, monitoring gaps can occur, which must be avoided under all circumstances.

One task of the invention is therefore to overcome the disadvantages mentioned and to provide for simple and consistent administration of monitoring data.

This task is solved with a method of the type mentioned in the introduction so that the monitoring data are administered centrally at a selected exchange on the intelligent network and transmitted upon request to the home exchange, which monitors the telecommunications terminal on the basis of these monitoring data.

A benefit of the invention to provide consistency of these data by administering monitoring data centrally and to facilitate simple expansion of the network by means of additional SSP exchanges without affecting the monitoring functionality. With the new, centralized administration method, any exchange on the network can be selected to receive the monitoring data. The monitoring official then needs to administer only the monitoring data at this exchange. In addition, the opportunities for potential errors is reduced that have resulted from the previously normal storage of n copies of data the data, where n corresponds to the number of exchanges at which the monitoring data are stored using the known decentralized administration method.

The monitoring data are administered advantageously at the selected exchange by means of a database.

A preferred variant of the invention provides that the request to transmit monitoring data when setting up an IN connection is generated with an additional telecommunications terminal at the home exchange and is transmitted to the selected exchange.

There can also be a provision that the request to transmit monitoring data when setting up an IN connection is generated with an additional telecommunications terminal and/or with activation of the telecommunications terminal to be monitored at the home exchange and is transmitted to the selected exchange.

The monitoring data are transmitted preferable according to the TCAP protocol.

A preferred variant of the invention provides that the transmitted monitoring data are stored at the home exchange for the duration of one monitoring process and are deleted again thereafter.

Other advantages can be achieved by providing a central administration unit that monitors whether a connection should be established with the subscription of the telecommunications terminal to be monitored and/or whether the telecommunications terminal will be activated, whereby messaging data are exchanged while initializing the establishment of a connection and/or activating the telecommunications terminal between the home exchange and the administration unit.

Preferably, messaging data are exchanged between the central administration unit and the home exchange through an INAP interface.

In addition, a monitoring job can be input into the central administration unit.

Special advantages can be achieved in that the monitoring job contains an IN address and/or an E.164 call number assigned to the telecommunications terminal to be monitored.

The result data from monitoring the home exchange can be sent to an evaluation unit for evaluation.

Especially suitable for implementing the method according to the invention is a telecommunications system of the kind mentioned in the introduction in which a selected exchange on the intelligent network is assigned to administer the monitoring data centrally and to transmit these data upon request to the home exchange, which is set up to monitor the telecommunications terminal on the basis of the monitoring data.

The selected exchange advantageously exhibits a database to administer the monitoring data.

The home exchange can also be set up to store the received monitoring data for the duration of one monitoring process and to delete them again thereafter.

Additional advantages can be achieved by setting up the telecommunications system to exchange messaging data between the home exchange and the central administration unit in case an IN telecommunications connection is supposed to be established with the subscription of the telecommunications terminal to be activated and/or in case this telecommunications terminal will be activated.

An INAP interface is envisioned for exchanging messaging data between the central administration unit and the home exchange.

An advantageous variant of the invention consist of setting up the central administration unit to receive a monitoring job.

The monitoring job can contain an IN address and/or E.164 call number assigned to the telecommunications unit to be monitored.

For evaluation purposes, result data from the monitoring of the home exchange can be transmitted to an evaluation unit.

The invention and additional advantages will be presented below on the basis of some non-restrictive examples that are illustrated in the drawing, where:

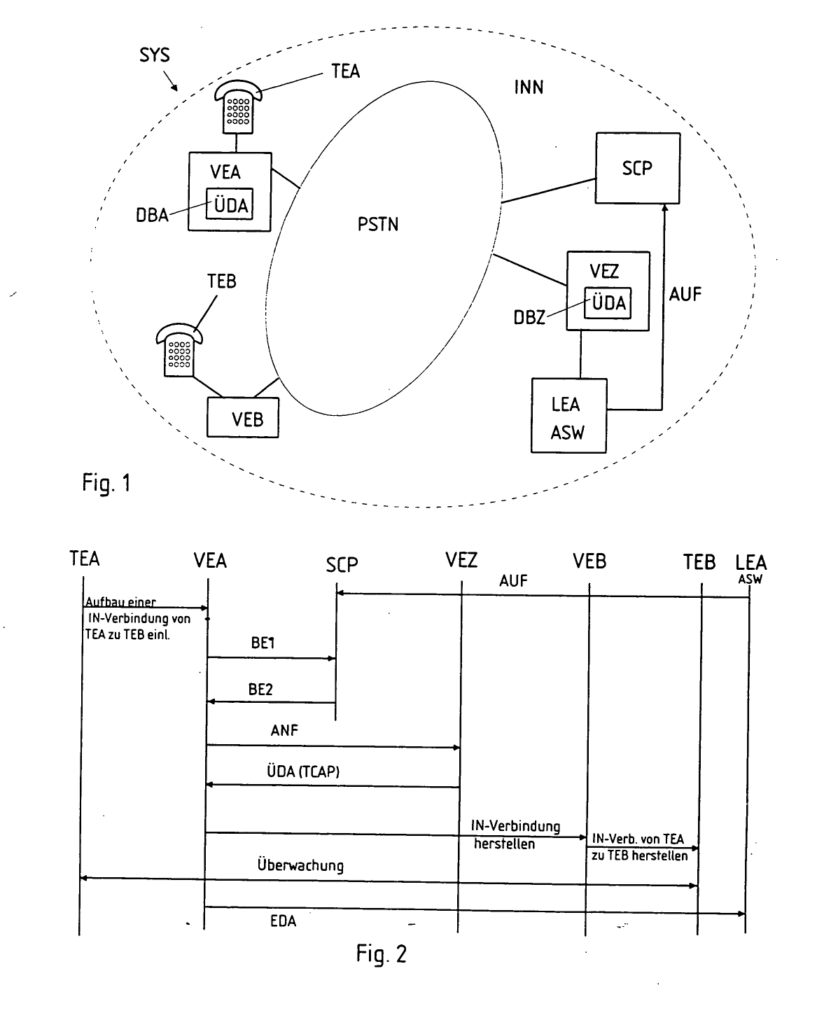

FIG. 1 shows a telecommunications system according to invention, and

FIG. 2 shows an example sequence of the method according to the invention.

According to FIG. 1, a telecommunications system SYS according to the invention for administering monitoring data ÜDA on an intelligent network INN has a home exchange VEA assigned to a telecommunications terminal TEA to be monitored and a selected exchange VEZ for central administration of monitoring data. To monitor the telecommunications device TEA, a monitoring job AUF is input into the central administration unit SCP, preferably a “service control point,” by an authorized agency. In the present embodiment example, the intelligent network INN is based on the PSTN network.

Both an IN address and an E.164 call number can be assigned to the telecommunications terminal TEA on the intelligent network INN. The central administration unit SCP is set up so that, after receiving the monitoring job AUF, which contains the IN address or the E.164 call number of the telecommunications terminal TEA, for example, it checks whether an IN connection should be established via this telecommunications terminal TEA or whether this telecommunications terminal will be activated. In this document, activating a telecommunications terminal means making use of system functions on the intelligent network INN, such as using an alarm service, for example.

In addition, monitoring data ÜDA are set up at a selected exchange VEZ. These monitoring data serve, as already been mentioned in the introduction, to execute a concrete monitoring job, and they can be administered at the selected exchange. A database DBZ is provided to administer the monitoring data ÜDA.

The monitoring data ÜDA can be administered by the monitoring agency LEA or automatically by the selected exchange VEZ.

Result data from monitoring can be sent to an evaluation unit ASW at the monitoring agency LEA.

The method according to the invention will now be explained in more detail using the example of an IN connection between two telecommunications terminals TEA, TEB. When an IN connection (FIG. 2) is established with the subscription of the telecommunications terminal to be monitored TEA and another telecommunications terminal TEB, the monitoring situation is detected by the central administration unit SCP and communicated to the subscriber exchange VEA of telecommunications terminal TEA, for example via an “intelligent network application protocol” interface, abbreviated INAP, not shown here. An INAP interface means a standardized interface for intelligent networks INN.

The subscriber exchange VEA now initiates communication, for example according to the “transmission capability applications part” protocol, abbreviated TCAP protocol, with the selected exchange VEZ that administers the monitoring data centrally and generates or transmits a request to transmit the monitoring data to the selected exchange VEZ.

A TCAP protocol means a connectionless SS#7 protocol for information exchange that is not related to a call or a connection.

SS#7 represents a known protocol, which was developed for signaling for digital telephone networks and has been standardized by the ITU-T. This method that is used on ISDN and mobile radio networks, for example GSM or DCS networks, involves so-called out-of-band or common-channel signaling. The signaling system in this case is separated from the transmission of user data and therefore exhibits its own network structure that can be established in parallel to the user data network. The SS#7 protocol is built in four layers. In the lower three layers, the protocol has a common message transport part for all applications. The transport part forms a transport system for user data, whereby the user part controls user channels and service characteristics. There are different user parts for line-transmitted data networks and for ISDN as well as application parts for mobile radio networks, for operation and maintenance, and for so-called intelligent networks. Data are transmitted at 64 kbit/sec as data packets over the signaling connections. The SS#7 protocol is normally used with IDSN, GSM, and ATM. A description of the SS#7 protocol can be found under ITU-T-Q.700 through Q.795.

Typically, the TCAP transaction runs through at least one system service control center that in the present example corresponds to the central administration unit SCP and through a message transport part. The system service control center administers the network configuration, coordinates network users, and administers network addresses and mapping tables, and the message transport part permits reliable and rapid transport of signal messages on the network.

After the monitoring data ÜDA for the present monitoring case have been received, they are stored temporarily on the home-exchange VEA for further use. For this purpose, a database DBA can be provided at this exchange, for example.

In order to find the selected exchange VEZ, its IN address can be transmitted to the home-exchange VEA of the monitoring telecommunications terminal TEA, for example by the central administration unit SCP. Another option consists in storing the IN network addresses of the selected exchange VEZ statically at the home-exchange VEA.

Finally, the IN connection is established through an exchange VEB assigned to the second telecommunications terminal (TEB), and the monitoring of data exchange between the two terminals is performed in a manner known from prior art, for example according to standard ETSI EG 201,781 V1.1 1, which was mentioned in the introduction. The result data EDA from this monitoring can be recorded on the home-exchange VEA, stored temporarily, and sent at a later time to the evaluation unit ASW of the monitoring agency LEA. Another option consists in delivering the result data EDA permanently to the evaluation unit ASW of the monitoring agency LEA.

After successful monitoring, the monitoring data ÜDA that have been stored temporarily on the home exchange VEA can be deleted.

1. A method for administering monitoring data (ÜDA) that serve to monitor a telecommunications terminal (TEA) by means of an assigned home exchange (VEA) on a centrally administered intelligent network (INN),
characterized in that the monitoring data (ÜDA) are centrally administered at a selected exchange (VEZ) on the centrally administered intelligent network and are transmitted upon request to the home exchange (VEA), which performs the monitoring of the telecommunications terminal (TEA) using these monitoring data (DAT).

2. A method according to claim 1,
characterized in that the monitoring data at the selected exchange (VEZ) are administered centrally by means of a database (DBZ).

3. A method according to claim 1 or 2,
characterized in that the request (ANF) to transmit the monitoring data (ÜDA) when establishing an IN connection is generated with an additional telecommunications terminal (TEB) at the home exchange (VEA) and is transmitted to the selected exchange (VEZ).

4. A method according to one of claims 1 through 3,
characterized in that the request (ANF) to transmit the monitoring data (ÜDA) when the telecommunications terminal (TEA) to be monitored is activated is generated by the home exchange (VEA) and transmitted to the selected exchange (VEZ).

5. A method according to one of claims 1 through 4,
characterized in that the monitoring data (ÜDA) are transmitted according to the TCAP protocol.

6. A method according to one of claims 1 through 5,
characterized in that the transmitted monitoring data (ÜDA) are stored at the home exchange (VEA) for the duration of one monitoring process (ÜMV) and deleted again thereafter.

7. A method according to one of claims 1 through 6,
characterized in that a central administration unit (SCP) is provided that monitors whether a connection should be set up with the subscription of the telecommunications terminal (TEA) to be monitored and/or whether the telecommunications terminal (TEA) is activated.

8. A method according to claim 7,
characterized in that a monitoring job (AUF) to monitor the telecommunications terminal (TEA) is input into the central administration unit (SPC).

9. A method according to claim 7 or 8,
characterized in that messaging data (BE1, BE2) are exchanged between the home exchange (VEA) and the administration unit (SPC) while establishing a connection and/or activating the telecommunications terminal (TEA).

10. A method according to claim 9,
characterized in that messaging data (BE1, BE2) are exchanged between the central administration unit (SPC) and the home exchange (VEA) through an INAP interface.

11. A method according to one of claims 8 through 10,
characterized in that the monitoring job (AUF) contains an IN address and/or E.164 call number assigned to the telecommunications terminal to be monitored.

12. A method according to one of claims 1 through 11,
characterized in that result data (EDA) from monitoring is transferred from the home exchange (VEA) to an evaluation unit (ASW).

13. A telecommunications system (SYS) set up to administer monitoring data (ÜDA) that serves to monitor a telecommunications terminal (TEA) by means of an assigned home exchange (VEA) on an intelligent network (INN), characterized in that a selected exchange (VEZ) on the intelligent network (INN) is set up to administer the monitoring data (ÜDA) centrally and to transmit these data upon request to the home exchange (VER), which is set up to monitor the telecommunications terminal (TEB) on using the monitoring data (DAT).

14. A telecommunications system according to claim 13,
characterized in that the selected exchange (VEZ) exhibits a database (DBZ) to administer the monitoring data.

15. A telecommunications system according to claim 13 or 14,
characterized in that the home exchange (VEA) is set up to generate a request (ANF) to transmit the monitoring data (ÜDA) when establishing an IN connection with an additional telecommunications terminal (TEB) and/or when activating the telecommunication terminal to be monitored (TEA) and to transmit it to the selected exchange (VEZ).

16. A telecommunications system according to one of claims 13 through 15,
characterized in that it is set up to transmit monitoring data (ÜDA) according to the TCAP protocol.

17. A telecommunications system according to one of claims 13 through 16,
characterized in that the home exchange (VEA) is set up to store the received monitoring data (ÜDA) for the duration of one monitoring process (ÜWV) and to delete them again thereafter.

18. A telecommunications system according to one of claims 13 through 17,
characterized in that a central administration unit (SCP) is provided that is set up to monitor whether an IN telecommunications connection is supposed to be created by means of the telecommunications terminal (TEA) assigned to it and/or whether this telecommunications device will be activated.

19. A telecommunications system according to claim 18,
characterized in that it is set up, in case an IN telecommunications connection is supposed to be created and/or whether activation takes place, to exchange messaging data (BE1, BE2)
between the home exchange (VEA) and the central administration unit (SPC).

20. A telecommunications system according to claim 19,
characterized in that it exhibits an INAP interface for exchanging messaging data (BEb 1, BE2) between the central administration unit (SPC) and the home exchange (VEA).

21. A telecommunications system according to one of claims 18 through 20,
characterized in that the central administration unit (SCP) is set up to receive a monitoring job (AUF).

22. A telecommunications system according to claim 21,
characterized in that the monitoring job (AUF) contains an IN address assigned to the telecommunications terminal to be monitored and/or an E.164 call number.

23. A telecommunications system according to one of claims 13 though 22,
characterized in that result data (EDA) from the monitoring are transferred from the home exchange (VEA) to an evaluation unit (ASW).
